(19) United States
(12) Patent Application Publication
(10) Pub. No.: US 2013/0033384 A1
(43) Pub. Date: Feb. 7, 2013

(54) CUSTOMIZED SYSTEM FOR VEHICLE DRIVING ASSISTANCE

(71) Applicants: Fabien Pierlot, Boulogne Billancourt (FR); Jean-Marc Van Laethem, Villiers Saint Frambourg (FR)

(72) Inventors: Fabien Pierlot, Boulogne Billancourt (FR); Jean-Marc Van Laethem, Villiers Saint Frambourg (FR)

(73) Assignee: COYOTE SYSTEM SAS, Suresnes (FR)

(21) Appl. No.: 13/511,931

(22) PCT Filed: Nov. 24, 2010
(86) PCT No.: PCT/FR2010/000780

§ 371 Date: Oct. 22, 2012

(30) Foreign Application Priority Data
Nov. 25, 2009 (FR) 0905662

(51) Int. Cl. G08G 1/0967

(52) U.S. Cl. 340/905

(57) ABSTRACT

A system for signaling a risk level in the presence of a road obstruction. The method is characterized in that the on-board device include a mechanism whereby the vehicle user inquires about the presence of an obstruction, a mechanism capable of enabling the user to respond to the inquiry, and a mechanism capable of communicating to the remote server the content of the response or non-response of the user. The remote server includes a mechanism for analyzing the response or non-response and capable of generating a reliability index parameter for the user. The on-board device also includes a mechanism capable of communicating to the vehicle user, in particular in visual form and/or audio form, information related to a reliability index parameter for the user(s) that have passed “over” the obstruction within a given time.

The present invention relates to a customized system for vehicle driving assistance, and more particularly to the means for evaluating the risk of the presence of road obstructions within an established zone of presence of the vehicle and to communicate this information to the vehicle driver.

There are a number of devices in existence designed to provide real-time guidance to vehicles and to inform the vehicle driver of a certain number of events capable of having an impact on driving conditions, such as the location of obstructions, including in particular traffic jams and road works, and the presence of radar devices, fog, patches of black ice, etc.

The majority of vehicles are therefore equipped with on-board computers, by means of which the driver can ascertain the configuration parameters of his vehicle and adjust some of them, if necessary, according to his navigation requirements.

These vehicles are also fitted with a satellite location receiver—GPS device—accompanied by a navigation system supplying the driver with all of the information he needs in order to make a particular journey, from a departure point to a destination point. Some of these navigation systems even include supplementary receiver facilities that receive information on the traffic and retransmit it, possibly with comments, to the user.

Devices also exist that can detect the proximity of speed detection radar devices and alert the driver to their presence and proximity.

The use of such devices is prohibited under the current legislation.

It is understood that, in order to perform such functions, these various devices must be equipped with an interactive interface allowing the driver to dialogue and exchange information with his device. However, this type of interaction requires the attention of the driver, which represents a safety risk when these actions are taken while the vehicle is in motion, since they divert the driver's attention from driving. For that reason, under the European regulations governing the design of on-board vehicle systems, the designers of such systems are required to ensure that the systems do not require lengthy interactions that cannot be interrupted, and also to ensure that certain data acquisition functions are deactivated while the vehicle is in motion.

In summary, these on-board navigation systems therefore need to satisfy two apparently contradictory conditions, by firstly allowing the driver to conduct an easy and detailed dialogue with the system, and secondly, presenting a particularly simplified user interface, in order to minimize, as much as possible, the attention level and actions required of the user.

In patent FR 2 896 462, the applicant proposed a driving aid system capable of reconciling these two requirements.

However, none of the various driving aid systems currently in existence provide the user with an indication enabling him to take account of the weight of the information communicated to him or the probability of encountering a particular obstruction, although this would be essential information for his driving safety.

This invention aims to remedy this problem by proposing a customized system for vehicle driving assistance incorporating a function that informs the driver of the reliability of the information communicated to him.

The purpose of this invention is therefore to have a system for signaling the level of risk of the presence of a road obstruction in a particular zone of presence of the vehicle, of a type consisting of:

an on-board device comprising:
the means for determining the vehicle location, such as GPS,
signaling facilities, by means of which the vehicle user can send the server, via remote communications facilities, the location coordinates of an obstruction encountered,
management facilities, such as a processor,

a remote server comprising:
the means for determining the location of an obstruction signaled by the on-board device using the information communicated by that device,
management facilities, such as a processor.

The on-board device and the remote server will have the means for remote, two-way communication, wherein:

the on-board device has the means enabling inquiries to be made to the vehicle user about the presence of an obstruction,

the on-board device has the means enabling the user to respond to that inquiry,

the on-board device has the means (21) for communicating to the remote server the content of the response or the failure by the user to respond,

the remote server has the means of analysis of this response or non-response and the means for generating a reliability index parameter for the user,

the on-board device has the means to communicate to the vehicle user, particularly in visual and/or audio form, information related to a reliability index parameter of the user(s) who have passed ‘over’ said obstruction within a specified time period.

The remote server will preferentially have the means for storing the user reliability indices, and the on-board device will have the means to activate an inquiry as to the presence of the obstruction immediately following the passage of the vehicle ‘over’ said obstruction.

Furthermore, the means of inquiry and response may be of any kind, and in particular may be vocal or visual.

The remote server may have the means to transmit to the on-board device the reliability index parameter of the user who signaled or confirmed an obstruction and/or the average reliability index parameter of several users who have signaled or confirmed a single obstruction.

The remote server will advantageously have the calculation capabilities for determining, from the reliability index of a user, or from the average reliability index of several users who have signaled or confirmed a single obstruction, an indication of the reliability of the information on the presence of the obstruction.

According to the invention, the remote server will include a database containing the locations of obstructions described as potential, existing on a statistical basis in a particular road zone, along with the probability of the presence of those obstructions within that location, and possibly also on a specified date and/or at a specified moment, as well as the means for measuring a user's system usage time within a specified time period, such as one day.

In order to allow batch processing of the obstructions signaled, the remote server will include a database capable of recording all of the obstructions signaled by its users during that period. It will also have calculation capabilities allowing it to modulate the probability of the presence of an obstruction according to the number or reliability index of the users who have passed ‘over’ that obstruction within an elapsed time period, for example the last half hour.

In order to improve the readability of the information communicated to the vehicle user,

the remote server will have the means for conflating the various parameters capable of influencing the probability of presence of an obstruction into a single indication of that probability, and possibly also the means for converting that indication into one or more signals. The on-board device will in turn have the means for displaying this signal on a screen. The signal will advantageously consist of a sign or a set of signs, the color of which will depend upon the level of probability of presence of the obstruction. For ease of attracting the vehicle user's attention, this color may occupy more than half of the surface of the display screen.

Furthermore, the remote server will have the means for determining the repetitive nature of obstructions signaled and for calculating, for a given place and moment, the probability of
presence of these so-called ‘potential’ obstructions, and may also have the means for modulating them, taking account, in particular, of the number of vehicles that have passed over a potential obstruction without signaling it and the reliability index of the users concerned. For this purpose, the remote server will have the means for counting these vehicles.

According to the invention, the reliability index of the users may consist of an arithmetic mean of the reliability indices of the users concerned.

Furthermore, the reliability index of a user may depend on a parameter proportional to that user's system usage time and/or a parameter proportional to his rate of participation and/or to his rate of confirmation, during a given time period.

The present invention also concerns an on-board device for vehicles, such device being designed to communicate with a remote server and having the means for determining the location of the vehicle, the means for communicating with the remote server and the means for conveying information to the vehicle user from the remote server in relation to the presence of road obstructions, wherein it comprises:
the means for making inquiries to the vehicle user as to the presence of an obstruction,
the means for responding to that inquiry,
the means for communicating to the remote server signals representing the content of the response or non-response from the user,
the means for supplying the vehicle user with information from the remote server in relation to a reliability index of a user who has signaled or confirmed the presence of an obstruction and/or an average reliability index of several users who have signaled or confirmed the presence of a single obstruction.

The on-board device will advantageously have the means for activating the inquiry as to the presence of an obstruction as soon as the vehicle has passed ‘over’ that obstruction. The means of inquiry and the means of response may be vocal and/or visual.

It may also have the means for informing the vehicle user, by visual and/or audio means, of the probability of the presence of an obstruction.

The information may preferentially be delivered to the user by means of display facilities in the form of a sign or a set of signs, the color of which may depend upon the level of probability of presence of the obstruction. These display facilities may consist of a screen (and said color may occupy more than half of its surface).

A description will be given later, by way of example and without limitation, of one embodiment of the present invention, with reference to the appended drawing, on which:

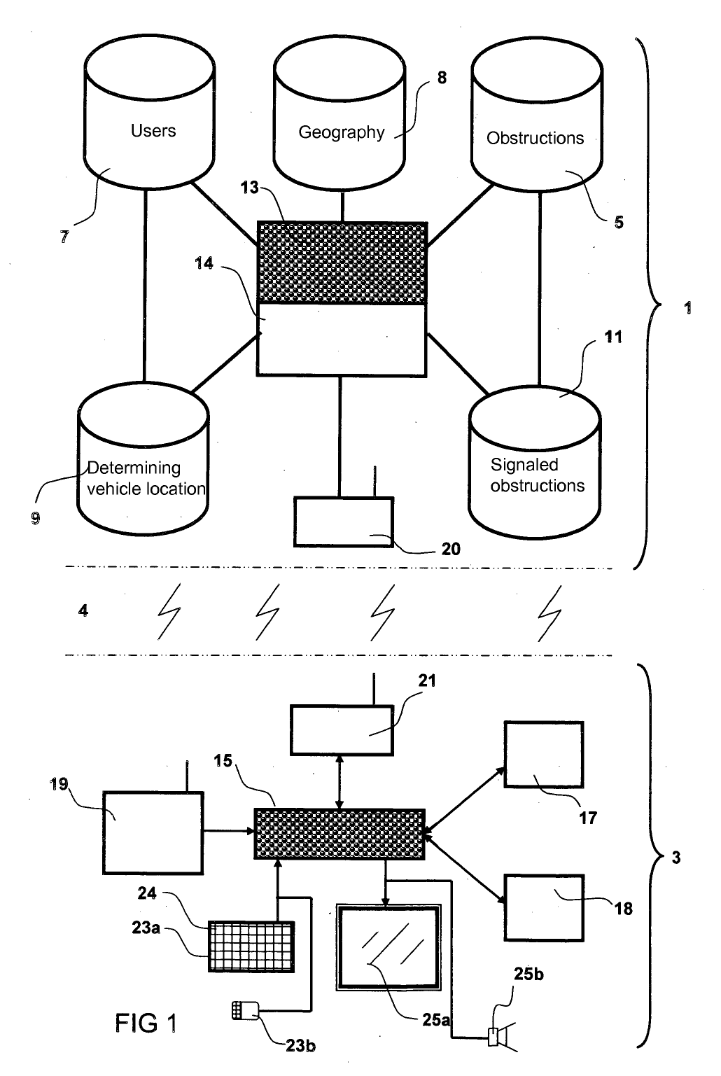

FIG. 1 is a schematic drawing showing the composition of a system according to the invention,

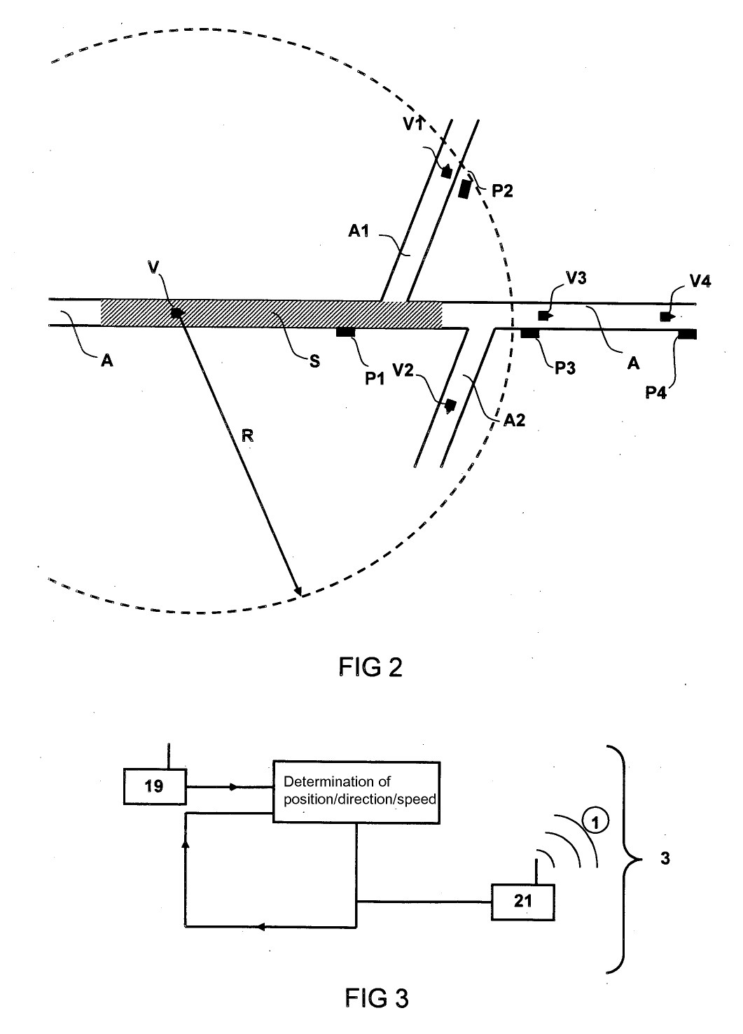

FIG. 2 is a schematic drawing showing traffic lanes in which obstructions are present, and on which vehicles managed by a system according to the invention are depicted,

FIGS. 3 to 8 are algorithms featuring the various stages of the implementation of the system according to the invention.

The system according to the invention depicted schematically in FIG. 1 essentially comprises a remote server 1 and an on-board device 3 on a vehicle.

The server 1 includes two sets of databases—referred to as a ‘statistical’ set and a ‘real-time’ set.

The set of a statistical nature comprises firstly a database 5 known as the ‘Obstructions base’. In this database, the coordinates of the various obstructions of a permanent or quasi-permanent nature present on the road network will have been stored, such as, for example, traffic jams, fixed radar devices, road works zones or zones in which accidents have occurred recently.

Secondly, it includes a database 7 known as the ‘Users base’, containing data of a statistical nature in relation to the users of vehicles equipped with a system according to the invention. Furthermore, given that the present invention proposes to take account of the weight of the information signaled to the system by the users, so that it can avoid taking account of fanciful information, whether deliberately so or not, the database 7—which is updated periodically by mean of batch processing, likely to be once a day, particularly at night—contains an index, IF, representing the reliability of the information sent by each of the users. This reliability index, IF, is established by a processor throughout the time that the system is used, on the basis of the behavior of the user, particularly when the user is in the presence of an obstruction, as described later.

It also comprises a database 8 known as the ‘Geographic base’, which makes it possible to determine the position of the vehicles on the main highways and also the position of the various obstructions, according to their coordinates of latitude L and longitude l.

The set of real-time databases consists of two databases—namely a database 9 known as the ‘Vehicle location database’, in which the position of all vehicles implementing the system according to the invention is kept up to date, and a database 11 known as the ‘Signaled obstructions database’, used for storing, in real time, the position of the obstructions detected by the users and signaled by them to the server 1, using the remote communications facilities, as explained below.

The statistical and real-time databases are managed by a processor 13, which is equipped with filtering facilities 14 for filtering the information received from the various on-board installations 3 on the vehicles implementing the system according to the invention.

The ‘Vehicle location’ base 9 maintains information, updated in real time, on the location—or in other words the latitude and longitude—of each of the vehicles implementing the system, along with their position on the traffic lanes, after the processor 13 has consulted the ‘Geography’ database 8. This data, and also the path taken by the vehicle on a given road segment S in the period just elapsed—using the specified time period T—is periodically sent by the on-board installation 3 to the remote server 1. This time period T may, for example, be of the order of half an hour.

This database is associated with calculation capabilities of the processor 13, which determine the lane A on which each of the vehicles is traveling, the segment S of that lane on which the vehicle is present during said time period T, the identity I of the vehicle's on-board device and the time of day H of the passage of the vehicle V through the road segment S. It will be noted that, according to the invention, a road segment S consists of a stretch taken on a single lane, for example between two different speed limits.

The processor 13 is thus able to determine how many vehicles n and which vehicles V₁, V₂, . . . Vₙ have passed through a place within the specified segment S during the elapsed time period T, and in which direction D those vehicles passed.

The second real-time database 11, known as the ‘Signaled obstructions base’, has the means for storing the obstructions P₁, P₂, . . . Pₙ signaled by the users and for classifying them in several categories, on the understanding that an obstruction of one category may, over time, develop into another. The processor 13 is therefore capable of managing two main categories of obstructions—namely real obstructions and potential obstructions. It therefore uses the following categories:

a) Real Obstructions:
obstructions pending confirmation: these are obstructions that have been signaled by one or more users whose reliability index IF is insufficient and which are being held pending confirmation. These obstructions are not taken into account by the processor,
active obstructions: these are obstructions signaled by one or more users and the presence of which has been confirmed. These obstructions are intended to be communicated to the vehicle users and are consequently taken into account by the processor, as explained later,
deactivated obstructions: these are obstructions that were active and which, as a result of action taken by users, have become inactive,

b) Potential Obstructions:

These are obstructions that, a priori, are not certain, but which depend upon external factors of a more or less fortuitous nature. For example, it may be known, in a specified zone, that climatic conditions are such that fog or black ice are often encountered—for example, in a given period of the year, it may be known that this occurs three days out of ten. Therefore, during that period of the year, there is a 30% chance of this obstruction in this zone. The probability of its presence P will thus be 30%.

The ‘Signaled obstructions base’ database 11 is associated with calculation capabilities of the processor 13, the function of which is to manage the saving of the data sent in real time by the users.

As shown in FIG. 1, each of the on-board devices 3 essentially consists of a processor 15, the role of which is to manage positioning facilities, consisting in particular of a GPS receiver 19, a RAM memory 17, and remote communications facilities—consisting in particular of a GPRS modem—allowing dialogue with the remote server 1.

The on-board device 3 also comprises addressing facilities, consisting in particular of a set of buttons 24 which may be grouped into a keypad 23a, by means of which a vehicle user sends information and instructions to the remote server 1 via a modem 21 and a GPRS network 4. These addressing facilities may also be of a vocal nature and may consist of a microphone 23b.

The on-board device 3 also comprises facilities allowing the user to receive information from the remote server 1. This information, which is managed by the processor 15, may be delivered visually to a display 25a and/or audibly by means of a loudspeaker 25b.

More precisely, as shown in the algorithm in FIG. 3, the GPS receiver 19 of each of the on-board systems determines in real time the location of the vehicle on which it is installed, or in other words the position, the direction of travel and the speed of that vehicle, and regularly—for example, every minute—transmits this information to the remote server 1 via the GPRS modem 21.

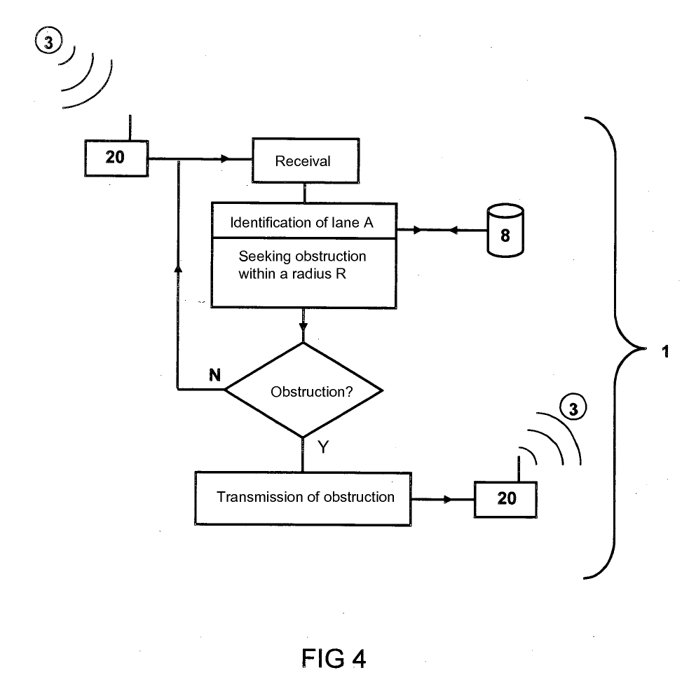

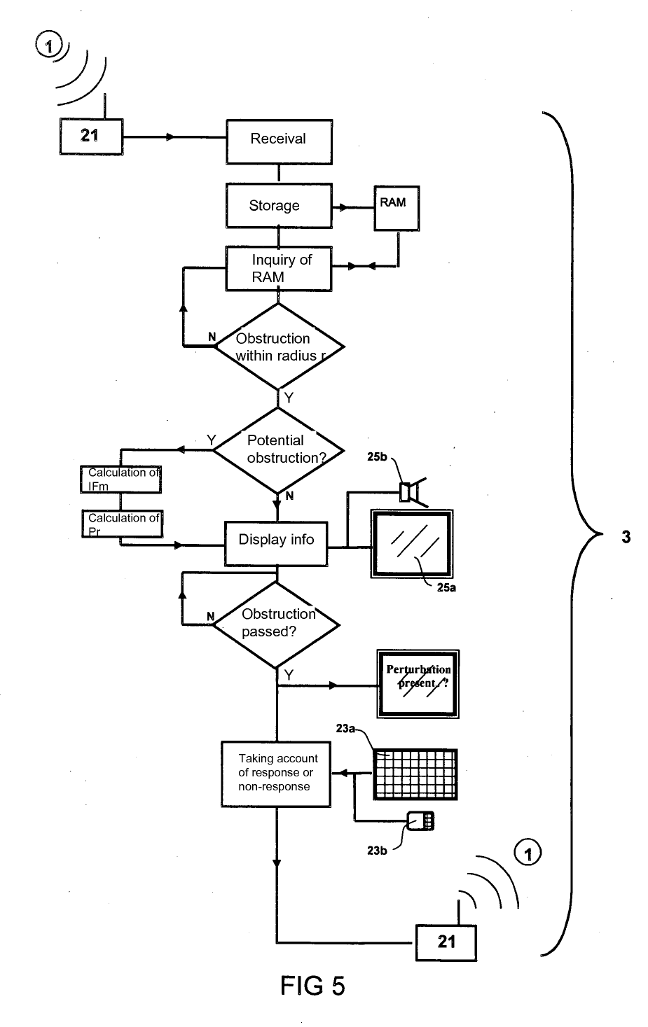

Upon receiving this, as represented in the algorithm in FIG. 4, the remote server 1 identifies the lane A on which the vehicle V is located, by comparison between the determination of location made by the on-board system and the information contained in the ‘Geographic base’ database 8, and defines the road segment S on which the vehicle is located. The remote server 1 also determines the direction D of travel of the vehicle V on the segment S.

The remote server 1 then, on the located lane A and also on the connected lanes A₁, A₂, . . . Aₙ (i.e. the lanes A₁ and A₂ in FIG. 2), searches for the obstructions P₁, P₂, . . . Pₙ that may exist within a specified monitoring radius R—for example, of the order of 20 km around the position of the vehicle V (i.e. the obstructions P₁ and P₂ in FIG. 2, P₁ being, for example, a new speed limit and P₂ being, for example, a fog patch). It then transmits information to the vehicle V, via its communications facilities 20 and the vehicle's GPRS modem 21, across the mobile telephony network. This information includes in particular:
the location of the detected obstructions P₁ and P₂, which are within the monitoring radius R, and the nature of those obstructions, which are contained in the ‘Obstructions base’ database 5 and the ‘Signaled obstructions’ database 11,
any instructions associated with those obstructions,
the reliability index IF of the system users who have previously passed ‘over’ these obstructions within the defined time period T, likely to be of the order of 30 minutes (i.e. in this case the vehicles V₁, V₂, V₃ and V₄), and the number of such users,
the statistical probability contained in the ‘Obstructions base’ database 5, concerning the potential obstructions. It will signal, in particular, the obstruction P2, supposing that this consists of fog, which occurs at this time of day during this season one day out of three, meaning a probability of 30%,

Upon receiving this, as represented in FIG. 5, the on-board device 3 of the vehicle V stores all of this information in its RAM memory 17, for later use by its processor 15 when the vehicle V comes within an alert distance r of an obstruction.

The processor makes a distinction between the management of real obstructions and potential obstructions, as defined previously.

a) Management of Real Obstructions:

If the vehicle V is approaching at an alert distance r from an obstruction stored in its RAM memory 17, likely to be of the order of 500 m, the processor 15 instructs its information facilities, such as the screen 25a and/or the loudspeaker 25b, to supply the following information:
the nature of the obstruction: accident, traffic jam, fixed or mobile radar device, black ice, fog, etc.
an instruction in relation to that obstruction,
the time of the latest observation,
the number n of users V₁, V₂, . . . Vₙ who have passed ‘over’ said obstruction (amounting to four vehicles in the example in FIG. 2—namely vehicles V₁, V₂, V₃ and V₄),
the average reliability index Iₘ of the users who passed ‘over’ that obstruction.

Once the GPS receiver 19 of the on-board device 3 locates the position of the vehicle V on which it is installed after the position of the obstruction concerned, the processor 15 generates a message on the display screen 25b, along the lines of “OBSTRUCTION STILL PRESENT?”, and offers the user a choice of YES/NO for a predefined duration, likely to be around 15 seconds. The processor 15 conveys the response, or non-response, to the remote server 1 where it will be further used by the processor 13, by means of batch processing, for updating the reliability index attributed to each user of the system according to the invention, which is stored in the ‘User base’ database 7 and which may change over time according to the behavior of that user vis-á-vis the system.

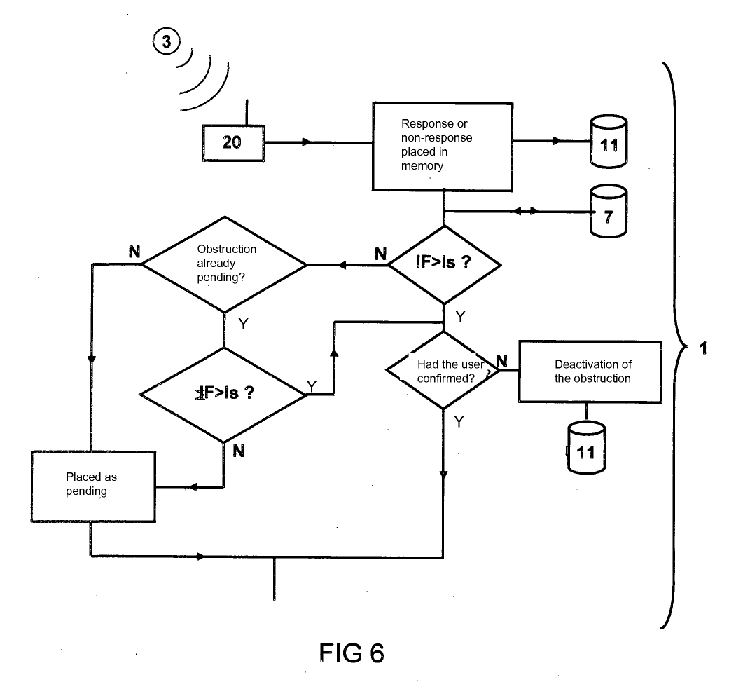

Following receipt of this, as shown in the algorithm in FIG. 6, the processor 13 first places the response or non-response received from the user in memory in the ‘Signaled obstructions base’ database 11, then consults the ‘User base’ database 7 in order to extract the reliability index IF of the user associated with the vehicle V. If that user has a reliability index IF greater than a threshold index Iₛ, it takes account of the information sent by the user.

This means that, if the user has invalidated the presence of the obstruction, the processor deactivates that obstruction in the ‘Signaled obstructions base’ database 11, and a new vehicle arriving at the same road segment S will no longer be informed of that obstruction, whereas if the user of the vehicle V has confirmed the obstruction, it remains active.

If, on the other hand, the user's reliability index IF is below the threshold index Iₛ, the processor gives the information pending status until such time as a new user confirms the information received from the first user. If this new user confirms the information from the first user, and if the sum of their respective reliability indices exceeds the threshold index Is, then the information is confirmed and the obstruction is declared not to be active.

If the user does not respond to the inquiry, this means that he does not wish to participate fully with the system, and this non-response is taken into account by the processor 13 and placed in memory in the database 11. When the time comes for the periodical batch processing of the various pieces of information conveyed to the remote server during a time period, for example a day, it may be taken into account by the processor for the purpose of reducing the confidence index IF of the user concerned.

b) Management of Potential Obstructions:

It will be recalled that an obstruction referred to as potential is an obstruction, the presence of which has been noted on many occasions, at a certain place, date and time of day. There is therefore a probability P that a user located at that place at the same moment will also encounter it.

The processor of the device according to the invention has specific calculation capabilities 14 designed to modulate this probability according to, firstly, the number of users nₚ who belong to this system and who have passed ‘over’ the obstruction in the recent past—which might, for example, be of the order of the last half hour—and who did not signal it, and, secondly, the reliability index IF of those users. The calculation capabilities 14 will preferentially establish an arithmetic mean IFₘ of the various reliability indices IF of the users concerned, such that:

Average reliability index: IFₘ=Σ(IF₁+IF₂+ . . . IFₙ)/nₚ

According to the invention, the processor considers that the real probability Pᵣ of encountering a potential obstruction is equal to the probability of its presence P, divided by the number of users nₚ who have passed ‘over’ the obstruction in a recently elapsed period without signaling it, divided by the average reliability index of those users, giving:

Pᵣ=P/α(1+nₚ×IFₘ)

Where α represents a coefficient of adjustment, the value of which will be established by experience, which is likely to mean by a method of an iterative type.

As shown in the algorithm of FIG. 5, if, when the processor 15 of the on-board device 3 consults its RAM memory 17, it detects that a potential obstruction exists within the alert distance r ahead of the vehicle V, it then proceeds to calculate the average reliability index IFₘ and then to calculate the real probability Pᵣ, as explained previously. Finally, the processor presents the following information, by displaying it on the screen 25a and/or by transmitting it through the loudspeaker 25b:
nature of the obstruction: accident, traffic jam, fixed or mobile radar device,
location of the obstruction,
instructions in relation to this obstruction,
probability Pᵣ of encountering the obstruction, in the case of a potential obstruction,
average reliability index IFₘ of the users concerned.

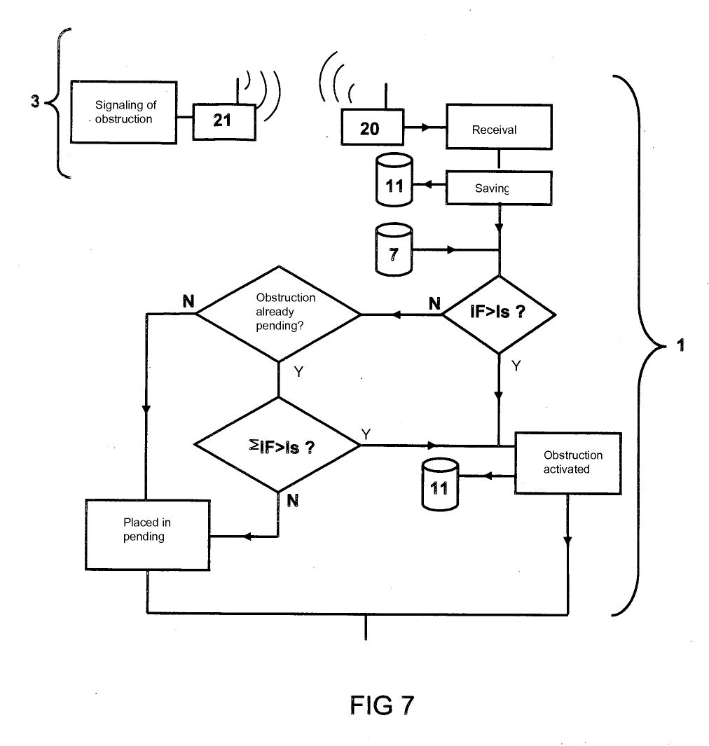

According to the invention, the real-time data comes from the users who, during their journeys, signal the obstructions that they encounter. Therefore, as represented in the algorithm of FIG. 7, when a user encounters an obstruction, he activates a button 24 that forms part of the signaling capabilities. This has the effect of sending a signal via the GPRS modem 21 to the remote server 1. This signal consists of a number of components—one component for the obstruction itself, another for its location, and an identification component that allows the processor 13 to know which user the information has come from.

The processor 13 first saves this information in the ‘Signaled obstructions base’ database 11, and then consults the ‘User base’ database 7, to find the reliability index IF associated with the user who issued the signal.

If this reliability index is greater than the minimum value Iₛ, the processor 13 takes account of the obstruction information transmitted to it and stores it in memory in the ‘Signaled obstructions base’ database 11, where it is classified within the category of ‘active’ obstructions. This means that this information will be communicated to any vehicle user entering the monitoring radius R of the lane A where it has been observed.

If the reliability index of the user who signaled the obstruction is lower than the threshold Iₛ, the processor 13 classifies the information within the ‘Signaled obstructions base’ database 11 in the category ‘pending confirmation’ and awaits confirmation from another user, in order to see whether the pending reliability indices are of a sufficient value to transfer the information into the ‘active’ category.

In a variant embodiment of this invention, the user has the possibility of configuring the conditions upon which he wishes to be alerted of obstructions of the potential kind

In one embodiment of this invention, the updating of the reliability indices of the system users is preferentially carried out periodically by batch processing, preferentially once a day, most likely at night.

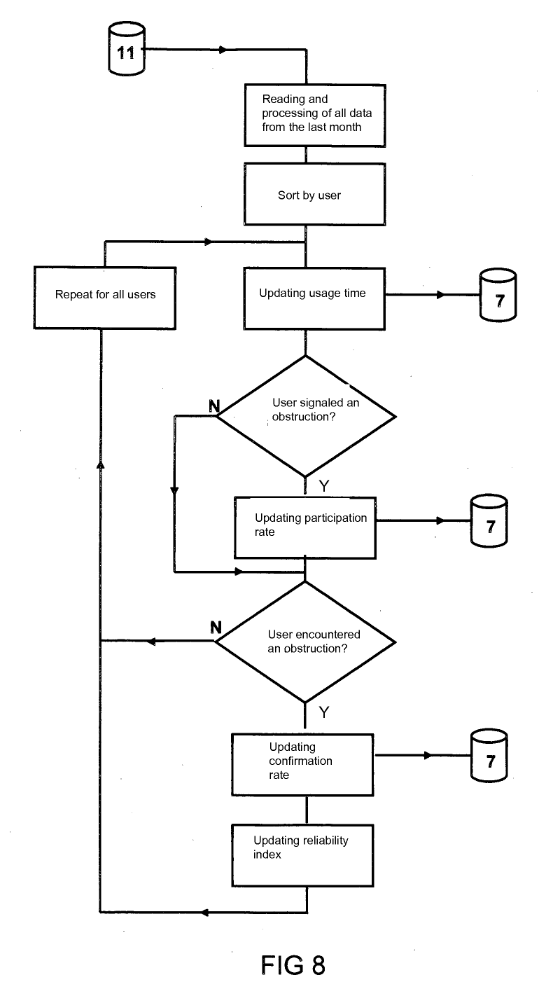

The various operations carried out using batch processing by the remote server, and more specifically by its processor 13, are represented in the algorithm in FIG. 8.

First of all, this processor 13 extracts from the ‘Signaled obstructions base’ database 11 the data stored during the last reference time period, likely to be the last month, and then proceeds to sort this data by user. Next, for each user, the processor updates the system usage time and stores it in the ‘User base’ database 7. Next, if the user has signaled existing obstructions and/or has encountered obstructions, the processor updates in the ‘User base’ database 7 the rate of participation of the user and also his rate of confirmations of obstructions that he has encountered.

Once these three parameters have been updated, the reliability index IF of that user is calculated and updated using the following formula:

IF=(α×usage time)+(β×participation rate)+(γ×confirmation rate)

where α, β and γ are adjustment parameters based on experience and used for weighting the parameters among themselves.

The processor follows this process for each of the users who have used the system according to the invention within the one-month time period.

1. System for signaling a level of risk of the presence of a road obstruction within a specified zone of presence of a vehicle, comprising:
an on-board device comprising:
the means for determining the location of the vehicle, such as GPS,
signaling facilities by which the vehicle user can send the server, using remote communications facilities, the location coordinates of an obstruction encountered,
management facilities, such as a processor,
a remote server comprising:
the means for determining the location of an obstruction signaled by the on-board device using the information communicated by that device,
management facilities, such as a processor,
the on-board device and the remote server having the means for remote, two-way communication, wherein:
the on-board device has the means for making inquiries to the vehicle user as to the presence of an obstruction,
the on-board device has the means for the user to respond to that inquiry,
the on-board device has the means for communicating to the remote server the content of the response, or the non-response, of the user,
the remote server has the means of analysis of this response or non-response and the means for generating a reliability index parameter for this user,
the on-board device has the means to communicate to the vehicle user, in particular in visual and/or audio form, an indication related to a reliability index parameter of the user(s) who have passed ‘over’ said obstruction within a specified time period.

2. System according to claim 1 wherein the remote server includes storage facilities for the reliability indices of the users.

3. System according to claim 1 wherein the on-board device has the means to activate the inquiry as to the presence of the obstruction as soon as the vehicle has passed ‘over’ the obstruction.

4. System according to claim 1 wherein the means of inquiry are of the vocal kind.

5. System according to claim 1 wherein the means of inquiry are of the visual kind.

6. System according to claim 1 wherein the means of response are of the vocal kind.

7. System according to claim 1 wherein the means of response include one or more control buttons.

8. System according to claim 1 wherein the remote server includes the means to transmit to the on-board device the reliability index parameter of the user who has signaled or confirmed an obstruction, and/or the average reliability index parameter of several users who have signaled or confirmed a single obstruction.

9. System according to claim 1 wherein the remote server includes calculation capabilities to determine, from the reliability index of a user, or from the average reliability index of several users who have signaled or confirmed a single obstruction, an indication as to the reliability of the information of the presence of an obstruction.

10. System according to claim 1 wherein the remote server includes a database containing the location of obstructions referred to as potential, which exist on a statistical basis on a specified road zone, along with the probability of presence of such obstruction in the location and, possibly, also at a specified date and/or time.

11. System according to claim 1 wherein the remote server has the means to measure a user's system usage time.

12. System according to claim 11 wherein the measurement of the usage time is carried out over a specified time period, which is likely to be one day or one month.

13. System according to claim 12 wherein it includes comprising a database capable of recording all of the obstructions signaled by its users during said time period.

14. System according to claim 13 wherein the remote server has calculation capabilities allowing it to modulate the probability of presence of an obstruction according to the number and/or reliability index of the users who have passed ‘over’ that obstruction within an elapsed time period, for example the last half hour.

15. System according to claim 14 wherein the remote server includes the means for conflating the various parameters capable of influencing the probability of presence of an obstruction into a single indication of that probability.

16. System according to claim 15 wherein the remote server includes the means for converting this indication of probability of presence into one or more signals.

17. System according to claim 16 wherein the on-board device has the means for displaying said signal on a screen.

18. System according to claim 17 wherein the signal comprises a sign or a set of signs, the color of which will depend upon the level of probability of presence of the obstruction.

19. System according to claim 18 wherein said color occupies more than half of the surface of the display screen.

20. System according to claim 1 wherein the remote server has the means for determining the repetitive nature of the obstructions signaled and for calculating, for a given place and moment, the probability of presence of those obstructions referred to as ‘potential’.

21. System according to claim 20 wherein the remote server has the means for modulating the probability of presence of the potential obstructions.

22. System according to claim 20 wherein the remote server includes the means for counting the number of vehicles that have passed over a potential obstruction without signaling.

23. System according to claim 21 wherein the means for modulating the probability of presence of the potential obstructions takes account of said number of vehicles and the reliability index of the users.

24. System according to claim 23 wherein the reliability index of the users comprises the arithmetic mean of the reliability indices of the users.

25. System according to claim 1 wherein the reliability index of a user is based on a parameter proportional to the system usage time by that user during a given time period.

26. System according to claim 1 wherein the reliability index of a user is based on a parameter proportional to the participation rate by that user during a given time period.

27. System according to claim 1 wherein the reliability index of a user is based on a parameter proportional to the confirmation rate by that user during a given time period.

28. An on-board device for a vehicle, such device being designed to communicate with a remote server and having the means to determine the location of the vehicle, the means of communication with the remote server and the means for conveying to the vehicle user information received from the remote server in relation to the presence of road obstructions, comprising:
the means for making inquiries to the vehicle user as to the presence of an obstruction,
the means of response to that inquiry,
the means for communicating to the remote server signals representing the content of the response or non-response from the user,
the means for supplying the vehicle user with information from the remote server in relation to a reliability index of a user who has signaled or confirmed the presence of an obstruction and/or an average reliability index of several users who have signaled or confirmed the presence of a single obstruction.

29. An on-board device according to claim 28 comprising the means for activating the inquiry as to the presence of an obstruction as soon as the vehicle has passed ‘over’ the obstruction.

30. An on-board device according to claim 28 wherein the means of inquiry are of the vocal kind.

31. An on-board device according to claim 28 wherein the means of inquiry are of the visual kind.

32. An on-board device according to claim 28 wherein the means of response are of the vocal kind.

33. An on-board device according to claim 28 wherein the means of response include one or more control buttons.

34. An on-board device according to claim 28 comprising the means for informing the vehicle user, by visual and/or audio means, of the probability of presence of an obstruction.

35. An on-board device according to claim 34 wherein this information is at least delivered on a means of display in the form of a sign or a set of signs, the color of which will depend upon the level of probability of the presence of the obstruction.

36. An on-board device according to claim 35 wherein the means of display comprises a screen, and said color occupies more than half of the surface of such screen.
